(19) United States
(12) Patent Application Publication
(10) Pub. No.: US 2023/0389012 A1
(43) Pub. Date: Nov. 30, 2023

(54) OBTAINING UPLINK RESOURCES FOR A LOGICAL CHANNEL WITHOUT AN ASSOCIATED SCHEDULING REQUEST CONFIGURATION

(71) Applicant: QUALCOMM Incorporated, San Diego, CA (US)

(72) Inventors: Krishna Chaitanya MUKKERA, San Diego, CA (US); Ambarish TRIPATHI, San Diego, CA (US); Peng WU, Shanghai (CN); Zhibin DANG, San Diego, CA (US); Bao Vinh NGUYEN, San Diego, CA (US); Shailesh MAHESHWARI, San Diego, CA (US)

(21) Appl. No.: 18/249,004

(22) PCT Filed: Dec. 18, 2020
(86) PCT No.: PCT/CN2020/137524

§ 371 Date: Apr. 13, 2023

(51) Int. Cl. H04W 72/1268; H04W 72/21

(52) U.S. Cl. CPC H04W 72/1268; H04W 72/21

(57) ABSTRACT

Various aspects of the present disclosure generally relate to wireless communication. In some aspects, a user equipment (UE) may determine that data is buffered for transmission via a first logical channel that does not have a valid scheduling request configuration. The UE may transmit, via a scheduling request resource of a second logical channel that has a valid scheduling request configuration, a scheduling request for resources to transmit the data buffered for transmission via the first logical channel. Numerous other aspects are described.

### FIELD OF THE DISCLOSURE

Aspects of the present disclosure generally relate to wireless communication and to techniques and apparatuses for obtaining uplink resources for a logical channel without an associated scheduling request configuration.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes determining that data is buffered for transmission via a first logical channel that does not have a valid scheduling request configuration; and transmitting, via a scheduling request resource of a second logical channel that has a valid scheduling request configuration, a scheduling request for resources to transmit the data buffered for transmission via the first logical channel.

In some aspects, a UE for wireless communication includes a memory; and one or more processors operatively coupled to the memory, the memory and the one or more processors configured to: determine that data is buffered for transmission via a first logical channel that does not have a valid scheduling request configuration; and transmit, via a scheduling request resource of a second logical channel that has a valid scheduling request configuration, a scheduling request for resources to transmit the data buffered for transmission via the first logical channel.

In some aspects, a non-transitory computer-readable medium storing a set of instructions for wireless communication includes one or more instructions that, when executed by one or more processors of a UE, cause the UE to: determine that data is buffered for transmission via a first logical channel that does not have a valid scheduling request configuration; and transmit, via a scheduling request resource of a second logical channel that has a valid scheduling request configuration, a scheduling request for resources to transmit the data buffered for transmission via the first logical channel.

In some aspects, an apparatus for wireless communication includes means for determining that data is buffered for transmission via a first logical channel that does not have a valid scheduling request configuration; and means for transmitting, via a scheduling request resource of a second logical channel that has a valid scheduling request configuration, a scheduling request for resources to transmit the data buffered for transmission via the first logical channel.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with various aspects of the present disclosure.

FIG. 2 is a diagram illustrating an example of a base station in communication with a UE in a wireless network, in accordance with various aspects of the present disclosure.

FIG. 3 is a diagram illustrating an example of receiving a resource grant for a logical channel using a random access channel procedure, in accordance with various aspects of the present disclosure.

FIG. 4 is a diagram illustrating an example associated with obtaining uplink resources for a logical channel without a scheduling request configuration, in accordance with various aspects of the present disclosure.

FIG. 5 is a diagram illustrating an example process associated with obtaining uplink resources for a logical channel without a scheduling request configuration, in accordance with various aspects of the present disclosure.

FIG. 6 is a block diagram of an example apparatus for wireless communication, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

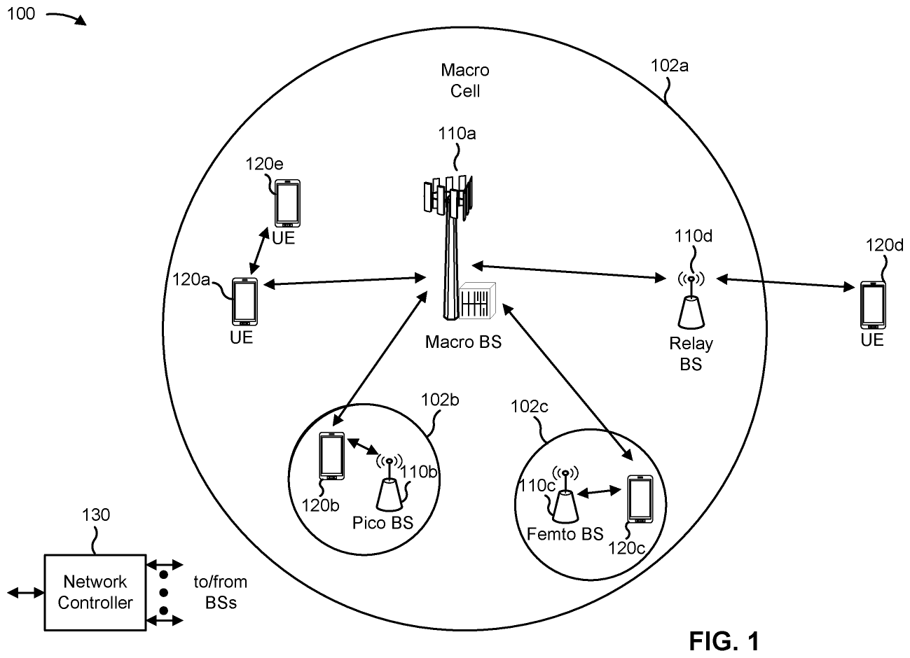

FIG. 1 is a diagram illustrating an example of a wireless network 100, in accordance with various aspects of the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. A BS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

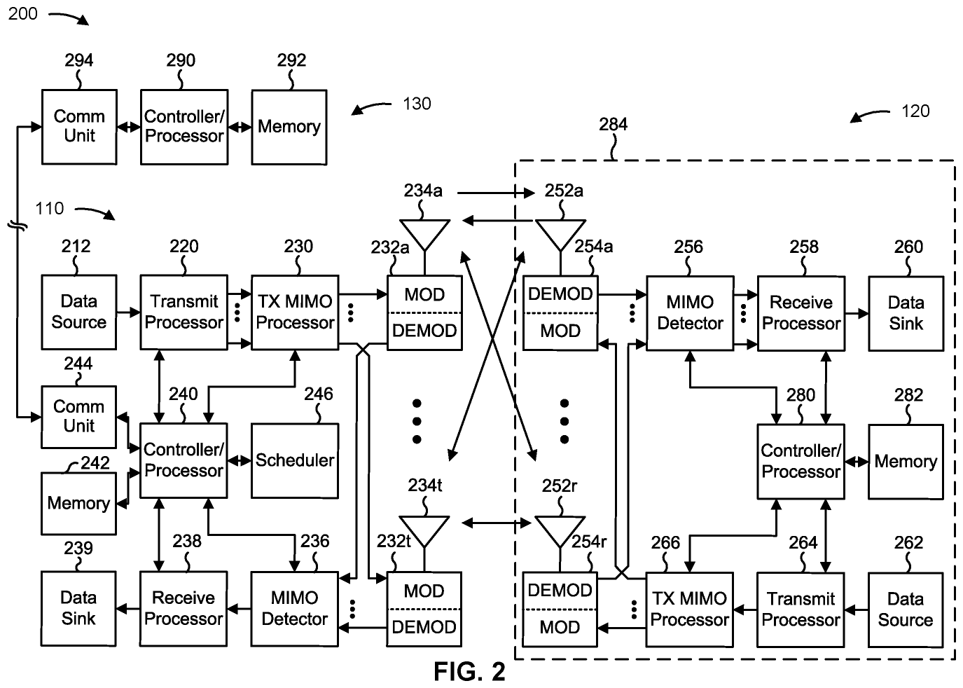

FIG. 2 is a diagram illustrating an example 200 of a base station 110 in communication with a UE 120 in a wireless network 100, in accordance with various aspects of the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a channel quality indicator (CQI) parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

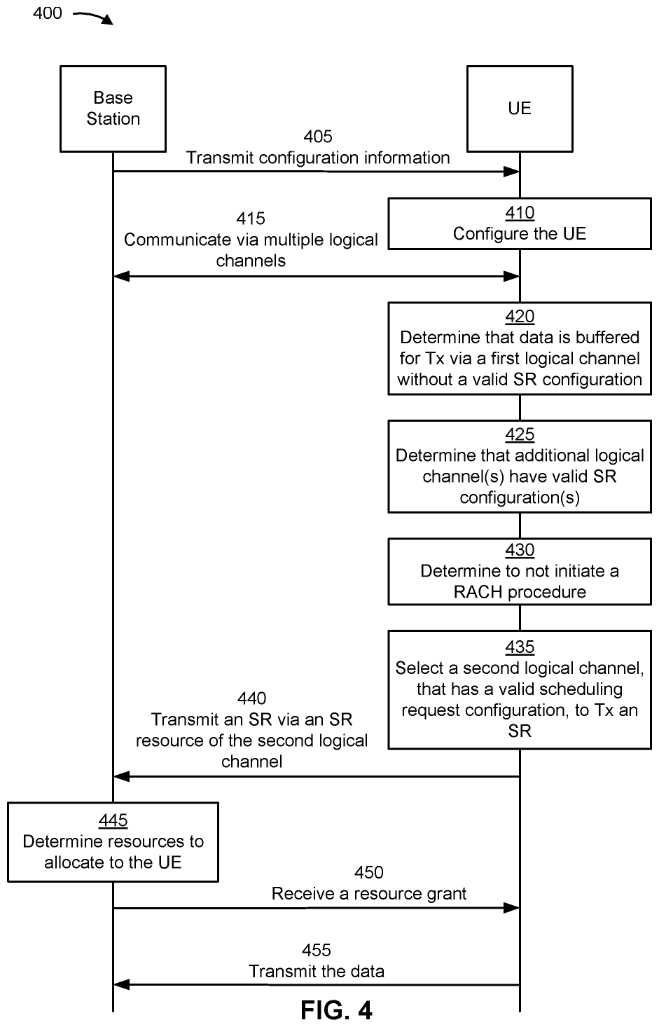

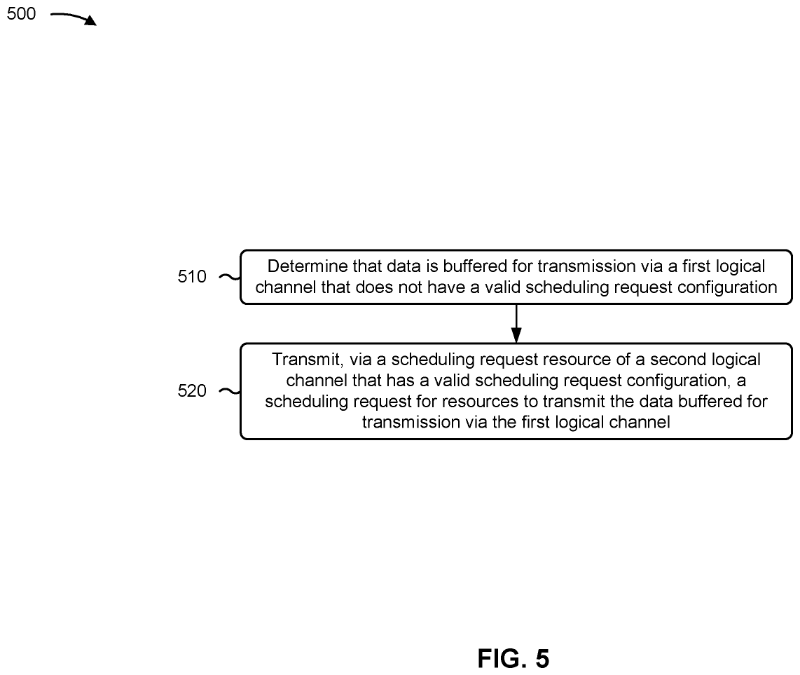

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 4 and 5.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 4 and 5.

Controller/processor 240 of base station 110, controller/processor 280 of UE 120, and/or any other component(s) of FIG. 2 may perform one or more techniques associated with obtaining uplink resources for a logical channel without an associated scheduling request configuration, as described in more detail elsewhere herein. For example, controller/processor 240 of base station 110, controller/processor 280 of UE 120, and/or any other component(s) of FIG. 2 may perform or direct operations of, for example, process 500 of FIG. 5 and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5, and/or other processes as described herein. In some aspects, executing instructions may include running the instructions, converting the instructions, compiling the instructions, and/or interpreting the instructions, among other examples.

In some aspects, the UE includes means for determining that data is buffered for transmission via a first logical channel that does not have a valid scheduling request configuration; and/or means for transmitting, via a scheduling request resource of a second logical channel that has a valid scheduling request configuration, a scheduling request for resources to transmit the data buffered for transmission via the first logical channel. The means for the UE to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the UE includes means for determining, after determining that the data is buffered for transmission via the first logical channel that does not have a valid scheduling request configuration, to not initiate a random access channel procedure based at least in part on a determination that the second logical channel has a valid scheduling request configuration.

In some aspects, the UE includes means for selecting the second logical channel from one or more logical channels that have valid scheduling request configurations based at least in part on a priority-based selection operation.

In some aspects, the UE includes means for selecting the second logical channel from one or more logical channels that have valid scheduling request configurations based at least in part on a random selection operation.

In some aspects, the UE includes means for receiving a resource grant that allocates resources for transmission of the data buffered for transmission via the first logical channel.

In some aspects, the UE includes means for transmitting, using the resources allocated by the resource grant, the data via the first logical channel.

In some aspects, the UE includes means for determining that additional data is buffered for transmission via the second logical channel; and means for transmitting at least a portion of one or more of the data or the additional data using the resources allocated by the resource grant

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

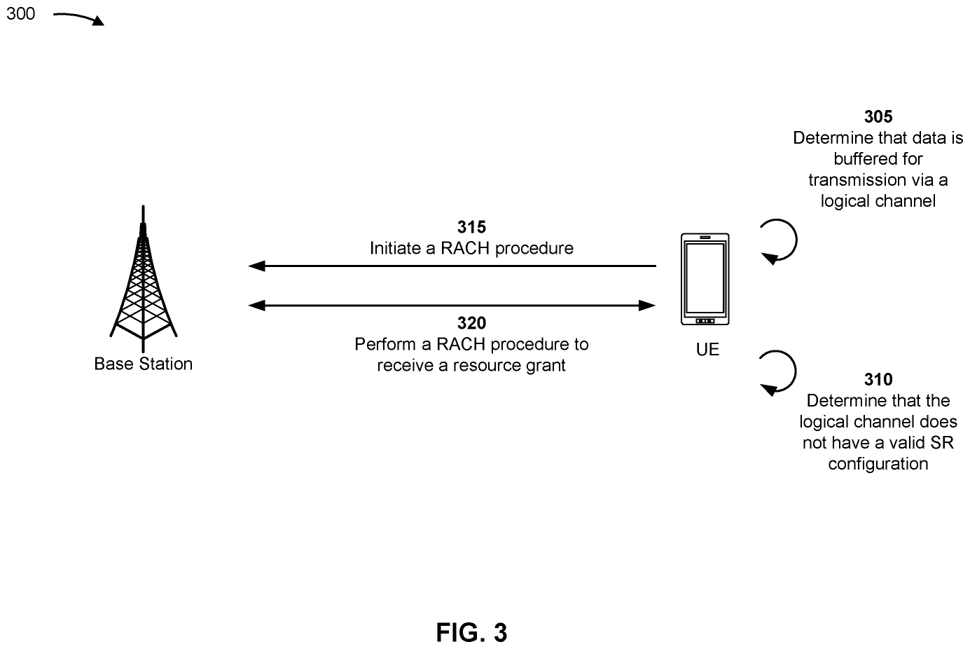

FIG. 3 is a diagram illustrating an example 300 of receiving a resource grant for a logical channel using a random access channel procedure, in accordance with various aspects of the present disclosure. As shown in FIG. 3, a UE and a base station may communicate via a wireless link (e.g., of an associated wireless network). The UE and the base station may establish one or more logical channels for communicating via the wireless link. For example, the UE and the base station may communicate using one or more logical channels that are carried on one or more physical channels, such as a physical uplink shared channel (PUSCH) and/or a physical downlink shared channel (PDSCH). A first logical channel and a second logical channel, of the one or more logical channels, may have different allocations of resources and/or different resource configurations, among other examples.

As shown by reference number 305, the UE may determine that data is buffered for transmission via a logical channel. For example, the UE may determine that the UE has data to transmit, via the wireless link, to an application server that is associated with the logical channel.

As shown by reference number 310, the UE may determine that the logical channel does not have a valid scheduling request (SR) configuration. In other words, the UE may determine that the UE does not have a scheduling request resource configured, for the logical channel, for the UE to indicate that the UE has data buffered to transmit via the logical channel.

As shown by reference number 315, the UE may initiate a random access channel (RACH) procedure. For example, the UE may initiate the RACH procedure based at least in part on transmitting a first message (e.g., Msg1 or MsgA) to the base station. The UE may transmit the first message using RACH resources that may be shared with one or more additional UEs.

As shown by reference number 320, the UE and the base station may perform a RACH procedure to receive a resource grant. For example, the UE and the base station may exchange one or more RACH messages as part of a 2-step RACH procedure or a 4-step RACH procedure.

Based at least in part on the UE initiating and performing a RACH procedure to receive a resource grant that allocates resources for the UE to transmit the data buffered for transmission via the logical channel, the UE and the base station may consume computing, network, power, and/or communication resources associated with performance of the RACH procedure. Additionally, or alternatively, based at least in part on the UE performing a RACH procedure to receive a resource grant, the UE may consume limited RACH resources, which may interfere with another UE attempting to perform a RACH procedure.

As indicated above, FIG. 3 is provided as an example. Other examples may differ from what is described with regard to FIG. 3.

In some aspects described herein, a UE may determine that the UE has data to transmit via a first logical channel. The UE may determine that the first logical channel does not have a valid scheduling request configuration for transmitting a scheduling request to request resources to transmit the data. The UE may determine that a second logical channel (e.g., through which the UE communicates with a base station) has a valid scheduling request configuration (e.g., has valid physical uplink control channel (PUCCH) resources configured for a scheduling request). Based at least in part on the second logical channel having a valid scheduling request configuration, the UE may determine to not initiate a RACH procedure to obtain resources to transmit the data. Instead, the UE may determine to use scheduling request resources of the second logical channel to transmit a scheduling request (e.g., to trigger a scheduling request) for resources to transmit the data.

Based at least in part on the UE transmitting a scheduling request for data, buffered for transmission via the first logical channel, using resources configured for transmitting a scheduling request for the second logical channel, the UE may conserve computing, network, power, and/or communication resources that may have otherwise been used to perform a RACH procedure to obtain resources to transmit the data. Additionally, or alternatively, the UE may conserve network resources allocated for RACH procedures, which may avoid interference with another UE attempting to perform a RACH procedure using limited RACH resources. Further, based at least in part on the UE transmitting a scheduling request for data, buffered for transmission via the first logical channel, using resources configured for transmitting a scheduling request for the second logical channel, the UE may reduce latency associated with transmitting the data buffered for transmission via the first logical channel.

FIG. 4 is a diagram illustrating an example 400 associated with obtaining uplink resources for a logical channel without a scheduling request configuration, in accordance with various aspects of the present disclosure. As shown in FIG. 4, a UE (e.g., UE 120) may communicate with a base station (e.g., base station 110). The UE and the base station may be part of a wireless network (e.g., wireless network 100).

As shown by reference number 405, the base station may transmit, and the UE may receive, configuration information. In some aspects, the UE may receive configuration information from another device (e.g., from another base station, TRP associated with the base station, and/or another UE, among other examples) and/or a communication standard, among other examples. In some aspects, the UE may receive the configuration information via one or more of radio resource control (RRC) signaling or medium access control control element (MAC-CE) signaling, and/or the UE may determine the configuration information from a communication standard, among other examples. In some aspects, the configuration information may include an indication of one or more configuration parameters (e.g., already known to the UE) for selection by the UE, explicit configuration information for the UE to use to configure the UE, and/or the like.

In some aspects, the configuration information may indicate that the UE is to communicate with the base station via one or more physical channels (e.g., PUSCH, PUCCH, PDSCH, and/or physical downlink control channel (PDCCH), among other examples). In some aspects, the configuration information may indicate that the UE is to communicate with the base station via one or more logical channels carried by, or within, the one or more physical channels. For example, the configuration information may indicate that the UE is to communicate via a first logical channel using a first set of resources of a physical channel and to communicate via a second logical channel using a second set of resources of the physical channel.

In some aspects, the configuration information may indicate that the UE, based at least in part on determining that data is buffered for transmission via a first logical channel that does not have a valid scheduling request, is to determine whether a second logical channel has a valid scheduling request configuration. In some aspects, the configuration information may indicate that the UE is to determine to not initiate a RACH procedure based at least in part on determining that the second logical channel has a valid scheduling request configuration. In some aspects, the configuration information may indicate that the UE is to select the second logical channel from one or more logical channels that have valid scheduling request configurations based at least in part on, for example, a priority-based selection operation or a random selection operation, among other examples.

In some aspects, the configuration information may indicate that the UE is to transmit a scheduling request via a scheduling request resource of the second logical channel (e.g., via a PUCCH resource). In some aspects, the configuration information may indicate that the UE is to receive a resource grant that allocates resources for transmission of the data and that the UE is to transmit at least a portion of the data via the first logical channel using the allocated resources.

As shown by reference number 410, the UE may configure the UE for communicating with the base station. In some aspects, the UE may configure the UE based at least in part on the configuration information. In some aspects, the UE may be configured to perform one or more operations described herein.

As shown by reference number 415, the UE and the base station may communicate via multiple logical channels. In some aspects, the base station may configure the multiple logical channels to operate using one or more physical channels. In some aspects, the base station may configure one or more of the multiple logical channels with valid scheduling request configurations and/or one or more others of the multiple logical channels without valid scheduling request configurations. In some aspects, the base station may configure different priorities for the multiple channels. The multiple channels may be associated with logical channel identifications (LCIDs).

As shown by reference number 420, the UE may determine that data is buffered for transmission via a first logical channel without a valid scheduling request configuration (e.g., that does not have a valid scheduling request resources). In some aspects, the UE may trigger a scheduling request based at least in part on the data being buffered for transmission via the first logical channel. The UE may determine that the first logical channel does not have a valid scheduling request configuration (e.g., the first logical channel does not have valid PUCCH resources configured for a scheduling request).

As shown by reference number 425, the UE may determine that one or more additional logical channels have one or more valid scheduling request configurations. For example, the UE may determine that a second logical channel and/or one or more additional logical channels have valid scheduling request configurations. The scheduling request configurations may include a configuration of resources for the UE to transmit, and the base station to receive, a scheduling request. For example, the second logical channel may have resources allocated within a PUCCH for the UE to indicate that the UE has data buffered for transmission to the base station.

As shown by reference number 430, the UE may determine to not initiate a RACH procedure. For example, the UE may determine to not initiate a RACH procedure based at least in part on a determination that an additional logical channel (e.g., the second logical channel) has a valid scheduling request configuration. The UE may determine that the UE may transmit a scheduling request via the scheduling request resources of the second logical channel instead of initiating the RACH procedure.

As shown by reference number 435, the UE may select a second logical channel, that has a valid scheduling request configuration, to transmit a scheduling request. For example, the UE may select the second logical channel, from a set of logical channels that have valid scheduling request configurations, that the UE may use to transmit the scheduling request (e.g., via scheduling request resources of the second logical channel). In some aspects, the UE may select the second logical channel based at least in part on a priority-based selection operation. For example, the UE may select the second logical channel based at least in part on the second logical channel having a highest priority, or a lowest priority, of the set of logical channels that have valid scheduling request configurations. In some aspects, the UE may select the second logical channel from the set of logical channels that have valid scheduling request configurations based at least in part on a random (e.g., a pseudorandom) selection operation.

As shown by reference number 440, the UE may transmit, and the base station may receive, a scheduling request via a scheduling request resource of the second logical channel. In some aspects, the UE may transmit the scheduling request via a PUCCH associated with the valid scheduling request configuration of the second logical channel. In other words, the UE may trigger a scheduling request using a scheduling request resource of the second logical channel.

As shown by reference number 445, the base station may determine resources to allocate to the UE (e.g., for transmission of the data buffered for transmission via the first logical channel). In some aspects, the base station may determine that the UE has data buffered for transmission. In some aspects, the base station may be unaware of a logical channel associated with the data buffered for transmission. In some aspects, the base station may determine to allocate resources of a PUSCH to the UE for transmission of the data.

As shown by reference number 450, the UE may receive, and the base station may transmit, a resource grant. In some aspects, the resource grant may allocate resources for transmission of the data buffered for transmission via the first logical channel. For example, the resource grant may allocate resources for one or more uplink transmissions, and the UE may determine to use the allocated resources to transmit the data buffered for transmission via the first logical channel.

As shown by reference number 455, the UE may transmit, and the base station may receive, the data. For example, the UE may transmit the data buffered for transmission via the first logical channel. In some aspects, the UE may determine that additional data is buffered for transmission via the second logical channel. In other words, the UE may determine that it has first data buffered for transmission via the first logical channel and second data buffered for transmission via the second logical channel. In some aspects, the UE may use resources allocated by the resource grant to transmit at least a portion of the data buffered for transmission via the first logical channel. In some aspects, the UE may use resources allocated by the resource grant to transmit at least a portion of the data buffered for transmission via the second logical channel. In some aspects, the UE may transmit the data and indicate (e.g., using a buffer status report (BSR)) that the UE has additional data to transmit. The base station may transmit one or more additional resource grants for the UE to use to transmit the first data and the second data.

Based at least in part on the UE transmitting a scheduling request for data, buffered for transmission via the first logical channel, using resources configured for transmitting a scheduling request for the second logical channel, the UE may conserve computing, network, power, and/or communication resources that may have otherwise been used to perform a RACH procedure to obtain resources to transmit the data. Additionally, or alternatively, the UE may conserve network resources allocated for RACH procedures, which may avoid interference with another UE attempting to perform a RACH procedure using limited RACH resources. Further, based at least in part on the UE transmitting a scheduling request for data, buffered for transmission via the first logical channel, using resources configured for transmitting a scheduling request for the second logical channel, the UE may reduce latency (e.g., compared with using a RACH procedure) associated with transmitting the data buffered for transmission via the first logical channel.

As indicated above, FIG. 4 is provided as an example. Other examples may differ from what is described with regard to FIG. 4.

FIG. 5 is a diagram illustrating an example process 500 performed, for example, by a UE, in accordance with various aspects of the present disclosure. Example process 500 is an example where the UE (e.g., UE 120) performs operations associated with obtaining uplink resources for a logical channel without an associated scheduling request configuration.

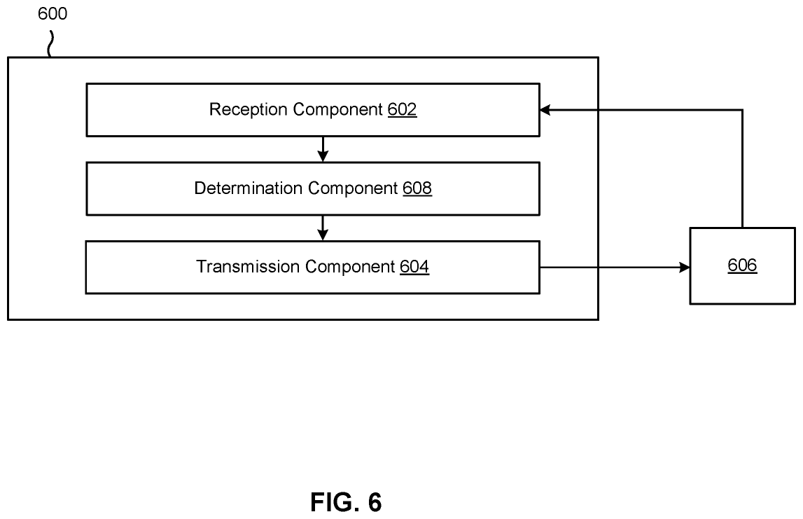

As shown in FIG. 5, in some aspects, process 500 may include determining that data is buffered for transmission via a first logical channel that does not have a valid scheduling request configuration (block 510). For example, the UE (e.g., using determination component 608, depicted in FIG. 6) may determine that data is buffered for transmission via a first logical channel that does not have a valid scheduling request configuration, as described above.

As further shown in FIG. 5, in some aspects, process 500 may include transmitting, via a scheduling request resource of a second logical channel that has a valid scheduling request configuration, a scheduling request for resources to transmit the data buffered for transmission via the first logical channel (block 520). For example, the UE (e.g., using transmission component 604, depicted in FIG. 6) may transmit, via a scheduling request resource of a second logical channel that has a valid scheduling request configuration, a scheduling request for resources to transmit the data buffered for transmission via the first logical channel, as described above.

Process 500 may include additional aspects, such as any single aspect or any combination of aspects described below and/or in connection with one or more other processes described elsewhere herein.

In a first aspect, process 500 includes determining, after determining that the data is buffered for transmission via the first logical channel that does not have a valid scheduling request configuration, to not initiate a random access channel procedure based at least in part on a determination that the second logical channel has a valid scheduling request configuration.

In a second aspect, alone or in combination with the first aspect, process 500 includes selecting the second logical channel from one or more logical channels that have valid scheduling request configurations based at least in part on a priority-based selection operation.

In a third aspect, alone or in combination with one or more of the first and second aspects, process 500 includes selecting the second logical channel from one or more logical channels that have valid scheduling request configurations based at least in part on a random selection operation.

In a fourth aspect, alone or in combination with one or more of the first through third aspects, process 500 includes receiving a resource grant that allocates resources for transmission of the data buffered for transmission via the first logical channel.

In a fifth aspect, alone or in combination with one or more of the first through fourth aspects, process 500 includes transmitting, using the resources allocated by the resource grant, the data via the first logical channel.

In a sixth aspect, alone or in combination with one or more of the first through fifth aspects, process 500 includes determining that additional data is buffered for transmission via the second logical channel, and transmitting at least a portion of one or more of the data or the additional data using the resources allocated by the resource grant.

In a seventh aspect, alone or in combination with one or more of the first through sixth aspects, transmitting the scheduling request comprises transmitting the scheduling request via a physical uplink control channel associated with the valid scheduling request configuration of the second logical channel.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a block diagram of an example apparatus 600 for wireless communication. The apparatus 600 may be a UE, or a UE may include the apparatus 600. In some aspects, the apparatus 600 includes a reception component 602 and a transmission component 604, which may be in communication with one another (for example, via one or more buses and/or one or more other components). As shown, the apparatus 600 may communicate with another apparatus 606 (such as a UE, a base station, or another wireless communication device) using the reception component 602 and the transmission component 604. As further shown, the apparatus 600 may include a determination component 608.

In some aspects, the apparatus 600 may be configured to perform one or more operations described herein in connection with FIG. 4. Additionally, or alternatively, the apparatus 600 may be configured to perform one or more processes described herein, such as process 500 of FIG. 5. In some aspects, the apparatus 600 and/or one or more components shown in FIG. 6 may include one or more components of the UE described above in connection with FIG. 2. Additionally, or alternatively, one or more components shown in FIG. 6 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 602 may receive communications, such as reference signals, control information, data communications, or a combination thereof, from the apparatus 606. The reception component 602 may provide received communications to one or more other components of the apparatus 600. In some aspects, the reception component 602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 606. In some aspects, the reception component 602 may include one or more antennas, a demodulator, a MIMO detector, a receive processor, a controller/processor, a memory, or a combination thereof, of the UE described above in connection with FIG. 2.

The transmission component 604 may transmit communications, such as reference signals, control information, data communications, or a combination thereof, to the apparatus 606. In some aspects, one or more other components of the apparatus 606 may generate communications and may provide the generated communications to the transmission component 604 for transmission to the apparatus 606. In some aspects, the transmission component 604 may perform signal processing on the generated communications (such as filtering, amplification, modulation, digital-to-analog conversion, multiplexing, interleaving, mapping, or encoding, among other examples), and may transmit the processed signals to the apparatus 606. In some aspects, the transmission component 604 may include one or more antennas, a modulator, a transmit MIMO processor, a transmit processor, a controller/processor, a memory, or a combination thereof, of the UE described above in connection with FIG. 2. In some aspects, the transmission component 604 may be co-located with the reception component 602 in a transceiver.

The determination component 608 may determine that data is buffered for transmission via a first logical channel that does not have a valid scheduling request configuration. The transmission component 604 may transmit, via a scheduling request resource of a second logical channel that has a valid scheduling request configuration, a scheduling request for resources to transmit the data buffered for transmission via the first logical channel.

The determination component 608 may determine, after determining that the data is buffered for transmission via the first logical channel that does not have a valid scheduling request configuration, to not initiate a random access channel procedure based at least in part on a determination that the second logical channel has a valid scheduling request configuration.

The determination component 608 may select the second logical channel from one or more logical channels that have valid scheduling request configurations based at least in part on a priority-based selection operation.

The determination component 608 may select the second logical channel from one or more logical channels that have valid scheduling request configurations based at least in part on a random selection operation.

The reception component 602 may receive a resource grant that allocates resources for transmission of the data buffered for transmission via the first logical channel.

The transmission component 604 may transmit, using the resources allocated by the resource grant, the data via the first logical channel.

The determination component 608 may determine that additional data is buffered for transmission via the second logical channel.

The transmission component 604 may transmit at least a portion of one or more of the data or the additional data using the resources allocated by the resource grant.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

The following provides an overview of aspects of the present disclosure:

Aspect 1: A method of wireless communication performed by a UE, comprising: determining that data is buffered for transmission via a first logical channel that does not have a valid scheduling request configuration; and transmitting, via a scheduling request resource of a second logical channel that has a valid scheduling request configuration, a scheduling request for resources to transmit the data buffered for transmission via the first logical channel.

Aspect 2: The method of aspect 1, further comprising: determining, after determining that the data is buffered for transmission via the first logical channel that does not have a valid scheduling request configuration, to not initiate a random access channel procedure based at least in part on a determination that the second logical channel has a valid scheduling request configuration.

Aspect 3: The method of any of aspects 1 to 2, further comprising: selecting the second logical channel from one or more logical channels that have valid scheduling request configurations based at least in part on a priority-based selection operation.

Aspect 4: The method of any of aspects 1 to 2, further comprising: selecting the second logical channel from one or more logical channels that have valid scheduling request configurations based at least in part on a random selection operation.

Aspect 5: The method of any of aspects 1 to 4, further comprising: receiving a resource grant that allocates resources for transmission of the data buffered for transmission via the first logical channel.

Aspect 6: The method of aspect 5, further comprising: transmitting, using the resources allocated by the resource grant, the data via the first logical channel.

Aspect 7: The method of aspect 5, further comprising: determining that additional data is buffered for transmission via the second logical channel; and transmitting at least a portion of one or more of the data or the additional data using the resources allocated by the resource grant.

Aspect 8: The method of any of aspects 1 to 7, wherein transmitting the scheduling request comprises: transmitting the scheduling request via a physical uplink control channel associated with the valid scheduling request configuration of the second logical channel.

Aspect 9: An apparatus for wireless communication at a device, comprising a processor; memory coupled with the processor; and instructions stored in the memory and executable by the processor to cause the apparatus to perform the method of one or more aspects of aspects 1-8.

Aspect 10: A device for wireless communication, comprising a memory and one or more processors coupled to the memory, the memory and the one or more processors configured to perform the method of one or more aspects of aspects 1-8.

Aspect 11: An apparatus for wireless communication, comprising at least one means for performing the method of one or more aspects of aspects 1-8.

Aspect 12: A non-transitory computer-readable medium storing code for wireless communication, the code comprising instructions executable by a processor to perform the method of one or more aspects of aspects 1-8.

Aspect 13: A non-transitory computer-readable medium storing a set of instructions for wireless communication, the set of instructions comprising one or more instructions that, when executed by one or more processors of a device, cause the device to perform the method of one or more aspects of aspects 1-8.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
determining that data is buffered for transmission via a first logical channel that does not have a valid scheduling request configuration; and
transmitting, via a scheduling request resource of a second logical channel that has a valid scheduling request configuration, a scheduling request for resources to transmit the data buffered for transmission via the first logical channel.

2. The method of claim 1, further comprising:
determining, after determining that the data is buffered for transmission via the first logical channel that does not have a valid scheduling request configuration, to not initiate a random access channel procedure based at least in part on a determination that the second logical channel has a valid scheduling request configuration.

3. The method of claim 1, further comprising:
selecting the second logical channel from one or more logical channels that have valid scheduling request configurations based at least in part on a priority-based selection operation.

4. The method of claim 1, further comprising:
selecting the second logical channel from one or more logical channels that have valid scheduling request configurations based at least in part on a random selection operation.

5. The method of claim 1, further comprising:
receiving a resource grant that allocates resources for transmission of the data buffered for transmission via the first logical channel.

6. The method of claim 5, further comprising:
transmitting, using the resources allocated by the resource grant, the data via the first logical channel.

7. The method of claim 5, further comprising:
determining that additional data is buffered for transmission via the second logical channel; and
transmitting at least a portion of one or more of the data or the additional data using the resources allocated by the resource grant.

8. The method of claim 1, wherein transmitting the scheduling request comprises:
transmitting the scheduling request via a physical uplink control channel associated with the valid scheduling request configuration of the second logical channel.

9. A user equipment (UE) for wireless communication, comprising:
a memory; and
one or more processors operatively coupled to the memory, the memory and the one or more processors configured to:
determine that data is buffered for transmission via a first logical channel that does not have a valid scheduling request configuration; and
transmit, via a scheduling request resource of a second logical channel that has a valid scheduling request configuration, a scheduling request for resources to transmit the data buffered for transmission via the first logical channel.

10. The UE of claim 9, wherein the one or more processors are further configured to:
determine, after determining that the data is buffered for transmission via the first logical channel that does not have a valid scheduling request configuration, to not initiate a random access channel procedure based at least in part on a determination that the second logical channel has a valid scheduling request configuration.

11. The UE of claim 9, wherein the one or more processors are further configured to:
select the second logical channel from one or more logical channels that have valid scheduling request configurations based at least in part on a priority-based selection operation.

12. The UE of claim 9, wherein the one or more processors are further configured to:
select the second logical channel from one or more logical channels that have valid scheduling request configurations based at least in part on a random selection operation.

13. The UE of claim 9, wherein the one or more processors are further configured to:
receive a resource grant that allocates resources for transmission of the data buffered for transmission via the first logical channel.

14. The UE of claim 13, wherein the one or more processors are further configured to:
transmit, using the resources allocated by the resource grant, the data via the first logical channel.

15. The UE of claim 13, wherein the one or more processors are further configured to:
determine that additional data is buffered for transmission via the second logical channel; and
transmit at least a portion of one or more of the data or the additional data using the resources allocated by the resource grant.

16. The UE of claim 9, wherein the one or more processors, when transmitting the scheduling request, are configured to:
transmit the scheduling request via a physical uplink control channel associated with the valid scheduling request configuration of the second logical channel.

17. A non-transitory computer-readable medium storing a set of instructions for wireless communication, the set of instructions comprising:
one or more instructions that, when executed by one or more processors of a user equipment (UE), cause the UE to:
determine that data is buffered for transmission via a first logical channel that does not have a valid scheduling request configuration; and
transmit, via a scheduling request resource of a second logical channel that has a valid scheduling request configuration, a scheduling request for resources to transmit the data buffered for transmission via the first logical channel.

18. The non-transitory computer-readable medium of claim 17, wherein the one or more instructions further cause the UE to:
determine, after determining that the data is buffered for transmission via the first logical channel that does not have a valid scheduling request configuration, to not initiate a random access channel procedure based at least in part on a determination that the second logical channel has a valid scheduling request configuration.

19. The non-transitory computer-readable medium of claim 17, wherein the one or more instructions further cause the UE to:
select the second logical channel from one or more logical channels that have valid scheduling request configurations based at least in part on a priority-based selection operation.

20. The non-transitory computer-readable medium of claim 17, wherein the one or more instructions further cause the UE to:
select the second logical channel from one or more logical channels that have valid scheduling request configurations based at least in part on a random selection operation.

21. The non-transitory computer-readable medium of claim 17, wherein the one or more instructions further cause the UE to:
receive a resource grant that allocates resources for transmission of the data buffered for transmission via the first logical channel.

22. The non-transitory computer-readable medium of claim 21, wherein the one or more instructions further cause the UE to:
transmit, using the resources allocated by the resource grant, the data via the first logical channel.

23. The non-transitory computer-readable medium of claim 21, wherein the one or more instructions further cause the UE to:
determine that additional data is buffered for transmission via the second logical channel; and
transmit at least a portion of one or more of the data or the additional data using the resources allocated by the resource grant.

24. An apparatus for wireless communication, comprising:
means for determining that data is buffered for transmission via a first logical channel that does not have a valid scheduling request configuration; and
means for transmitting, via a scheduling request resource of a second logical channel that has a valid scheduling request configuration, a scheduling request for resources to transmit the data buffered for transmission via the first logical channel.

25. The apparatus of claim 24, further comprising:
means for determining, after determining that the data is buffered for transmission via the first logical channel that does not have a valid scheduling request configuration, to not initiate a random access channel procedure based at least in part on a determination that the second logical channel has a valid scheduling request configuration.

26. The apparatus of claim 24, further comprising:
means for selecting the second logical channel from one or more logical channels that have valid scheduling request configurations based at least in part on a priority-based selection operation.

27. The apparatus of claim 244, further comprising:
means for selecting the second logical channel from one or more logical channels that have valid scheduling request configurations based at least in part on a random selection operation.

28. The apparatus of claim 24, further comprising:
means for receiving a resource grant that allocates resources for transmission of the data buffered for transmission via the first logical channel.

29. The apparatus of claim 28, further comprising:
means for transmitting, using the resources allocated by the resource grant, the data via the first logical channel.

30. The apparatus of claim 28, further comprising:
means for determining that additional data is buffered for transmission via the second logical channel; and
means for transmitting at least a portion of one or more of the data or the additional data using the resources allocated by the resource grant.
